(19) United States
(12) Patent Application Publication
(10) Pub. No.: US 2026/0284878 A1
(43) Pub. Date: Sep. 24, 2026

(54) ROBOT PARAMETER SETTING APPARATUS

(71) Applicant: FANUC CORPORATION, Minamitsuru-gun, Yamanashi (JP)

(72) Inventor: Kyouhei KOKUBO, Yamanashi (JP)

(73) Assignee: FANUC CORPORATION, Minamitsuru-gun, Yamanashi (JP)

(21) Appl. No.: 18/879,987

(22) PCT Filed: Jul. 28, 2022
(86) PCT No.: PCT/JP2022/029131

§ 371 Date: Dec. 30, 2024

(51) Int. Cl. B25J 9/16; B25J 9/00; B25J 13/06; B25J 13/08

(52) U.S. Cl. CPC B25J 9/1664; B25J 9/0081; B25J 9/1674; B25J 13/06; B25J 13/088

(57) ABSTRACT

A robot parameter setting apparatus including a first setting element which is either one of a target and a sensor and which is attached to an arm, a second setting element which is the other one, and a controller configured to control the arm to execute parameter setting operation by placing the first setting element at a plurality of positions. The controller controls the sensor to acquire first check data in a state where the first setting element is placed at a setting check position in a first half of or before the setting operation, and controls the arm to execute a movement for placing the first setting element at the setting check position in a latter half of or after the setting operation, and then controls the sensor to acquire second check data, and judges whether there is a change in position based on the data.

This application is a national phase of International Application No. PCT/JP2022/029131, filed Jul. 28, 2022, which is incorporated herein by reference in its entirety.

### TECHNICAL FIELD

The present disclosure relates to a robot parameter setting apparatus.

### BACKGROUND ART

There is a known apparatus for measuring a position of a tool-distal-end point with respect to a distal end portion of an arm of a robot. Also, there is a known apparatus that associates position information, which is in an image acquired by a visual sensor, with position information of the robot. Also, there is a known apparatus that associates a camera coordinate system with a robot coordinate system by using a master workpiece. Further, there is a known robot system that conducts works to a fixed target device wherein the robot is placed on a cart. In this robot system, a plurality of marks are provided on the target device, and a position of the target device with respect to the robot on the cart is grasped by using the plurality of marks as landmarks. For example, see PTLs 1 to 4.

### CITATION LIST

### Patent Literature

Japanese U.S. Pat. No. 4,191,080
Japanese Unexamined Patent Application, Publication No. 2015-174191
Japanese Unexamined Patent Application, Publication No. 2018-034271
Japanese Unexamined Patent Application, Publication No. 2020-163518

### SUMMARY

A robot parameter setting apparatus according to an aspect of the present invention includes a first setting element which is either one of a target and a sensor and which is attached to an arm of a robot; a second setting element which is the other one of the target or the sensor; and a controller configured to control the arm to execute parameter setting operation for setting parameter by placing the first setting element at a plurality of positions, wherein the controller is configured to control the sensor to acquire first check data related to the target in a state in which the first setting element is placed at a setting check position in a first half of the setting operation or before executing the setting operation, the controller is configured to control the arm to execute a movement for placing the first setting element at the setting check position in a latter half of the setting operation or after executing the setting operation, and then controls the sensor to acquire second check data related to the target, and the controller is configured to judge whether or not there is a change in position of the first setting element or the second setting element based on the first check data and the second check data.

### BRIEF DESCRIPTION OF DRAWINGS

FIG. 1 is a schematic perspective view of a parameter setting apparatus and a robot system in which the parameter setting apparatus is used according to a first embodiment.

FIG. 2 is a schematic side surface view of the robot system of the first embodiment.

FIG. 3 is a block diagram of a controller of the robot parameter setting apparatus of the first embodiment.

FIG. 4 is a block diagram of an image processor of the robot parameter setting apparatus of the first embodiment.

FIG. 5 is a flowchart of an example of processing executed by the controller of the robot parameter setting apparatus of the first embodiment.

FIG. 6 is a flowchart of an example of processing executed by the controller of the robot parameter setting apparatus of the first embodiment.

FIG. 7 is a display example of a display device of the robot parameter setting apparatus of the first embodiment.

FIG. 8 is a schematic perspective view of a parameter setting apparatus and a robot system in which the parameter setting apparatus is used according to a second embodiment.

FIG. 9 is a flowchart of an example of processing executed by the controller of the robot parameter setting apparatus of the second embodiment.

FIG. 10 is a flowchart of an example of processing executed by the controller of the robot parameter setting apparatus of the second embodiment.

### DESCRIPTION OF EMBODIMENTS

In order to make a robot work on a work target, it is necessary to associate a robot coordinate system with a coordinate system of a tool located at a distal end portion of the robot, to associate a coordinate system regarding the robot with a coordinate system regarding the work target, and the like. For example, the coordinate system of the tool located at the distal end portion of the robot is required to be associated with a coordinate system of the work target conveyed by a conveyer.

When associating these coordinate systems, either one of a target such as a mark captured by a visual sensor and the like and the visual sensor is held by an arm of the robot, and the other one is supported by a predetermined support portion. And, based on a coordinate system setting program, the distal end portion of the arm moves to various positions. Also, based on the coordinate system setting program, the visual sensor acquires images of the target at each position, and the coordinate systems are associated based on the acquired image data.

This setting is executed on the assumption that the positions of the target and the visual sensor do not change. However, for example, there may be a case in which tension, inertial force, and the like are acted on a cable of the visual sensor, and in this case, displacement of the visual sensor may occur at the time of the above setting. Therefore, it is desired to provide a robot parameter setting apparatus that can ensure unintended situation does not occur.

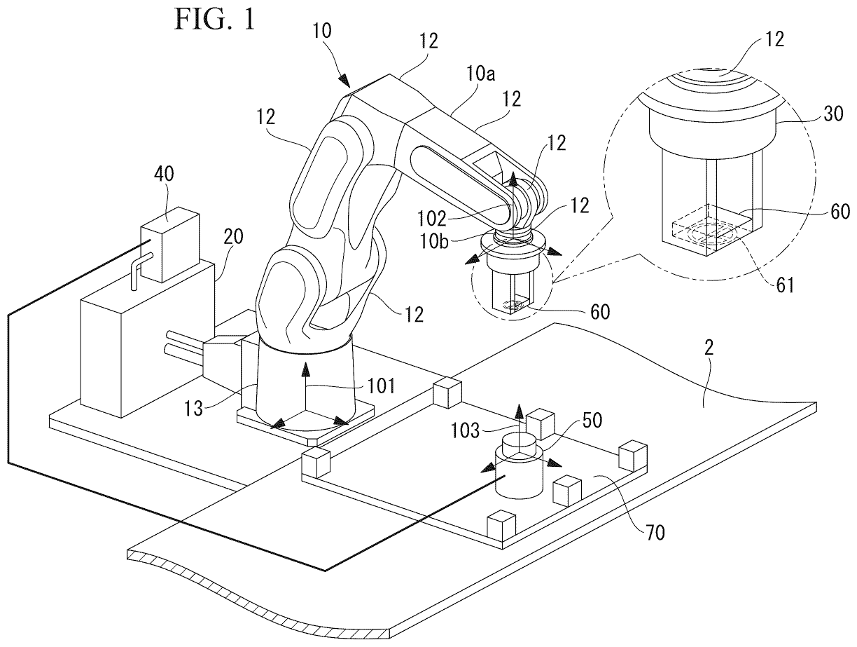

A robot parameter setting apparatus according to a first embodiment will be described with reference to the drawings. As shown in FIG. 1, this setting apparatus includes a controller 20 for a robot 10, a visual sensor (a sensor) 50 that is connected to the controller 20, and an image processor 40. The controller 20 may play a function of the image processor 40, and in this case, the image processor 40 can be omitted. Also, another computer may partially play a function of a later described processing. In this case, the other computer is included in this setting apparatus.

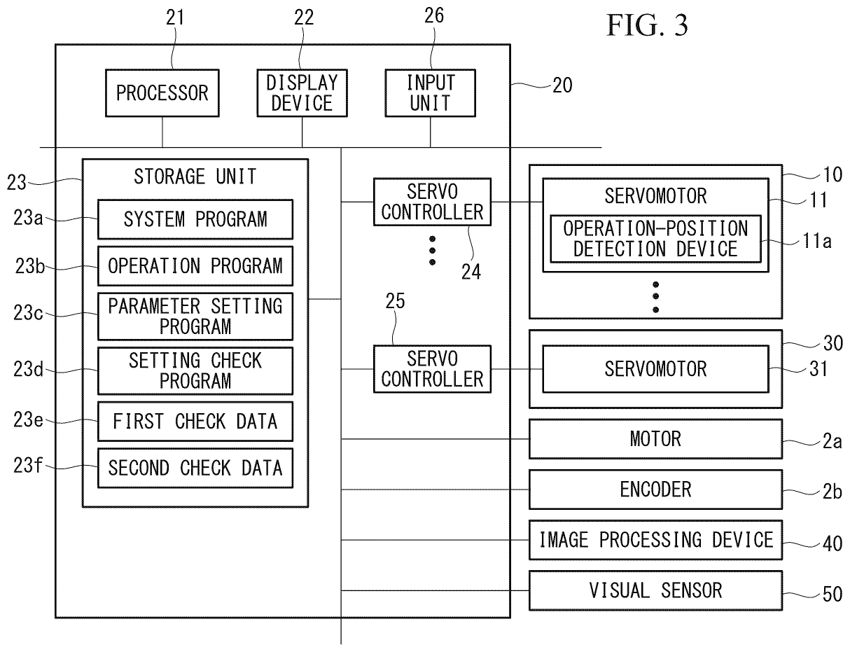

The robot 10 is not limited to a particular type, however, the robot 10 according to the first embodiment is an articulated robot having six axes. The robot 10 may be a horizontal articulated robot, a multi-link robot, and the like. An arm 10a includes a plurality of servo motors 11 that respectively drive a plurality of movable portions 12 (see FIGS. 1 and 3). Each servo motor 11 has an operating-position detection device 11a for detecting its operating position, and an example of the operating-position detection device 11a is an encoder. The controller 20 receives the detected value of the operating-position detection device 11a.

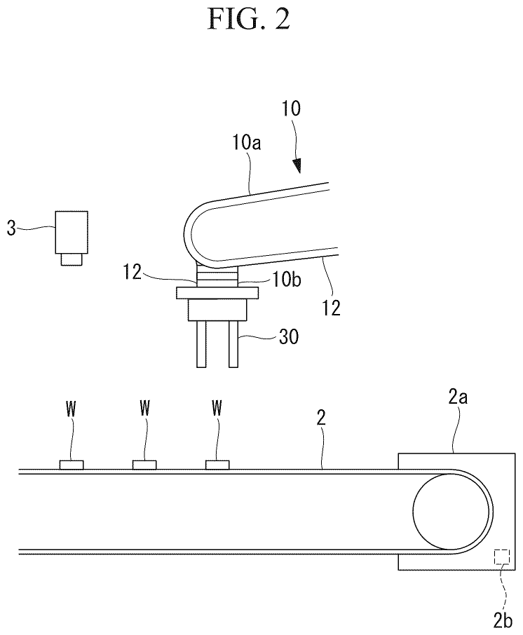

As shown in FIG. 2, a tool 30 is attached to a distal end portion of the arm 10a, for example, and the arm 10a is a part of a robot system that conducts work on a work target W in a conveyance device 2. In an example of FIG. 2, a camera 3 other than the visual sensor 5 is provided in order to check a position and orientation of the work target located at an upper stream side of the conveyance device 2. Also, an encoder (operating-position detection device) 2b that detects conveyance amount of the conveyance device 2 is provided in a motor (a driving device) 2a for driving the conveyance device 2. Also, the controller 20 controls the distal end portion of the arm 10a to follow the work target W during the working time by using the position of the work target W detected based on an output of the camera 3 and the conveyance amount of the conveyance device 2.

The above described work is a known work such as picking the work target W, processing on the work target W, mounting parts on the work target W, and the like. The processing on the work target W is known processing such as machining, painting, washing, and the like. The conveyance device 2 may be any device as long as it can move the work target W such as a conveyer, an AGV (Automatic Guided Vehicle), a vehicle under manufacturing, and the like. In such a case where the conveyance device 2 is the vehicle under manufacturing, a chassis, a tire, a motor, and the like function as the conveyance device 2, and a body and the like on the chassis is conveyed as the work target W.

In one example, the tool 30 is a hand, and the tool 30 includes a servo motor 31 that drives claws (see FIG. 3). The servo motor 31 has an operating-position detection device for detecting its operating position, and an example of the operating-position detection device is an encoder. The detected value obtained by the operating-position detection device is sent to the controller 20. As each of the servo motors 11 and 31, various types of servo motors, such as a rotary motor, a linear motor, and the like can be employed.

In one example, the visual sensor 50 is supported by an upper surface of the conveyance device 2. In the first embodiment, the visual sensor 50 is supported by a predetermined supporting portion 70 (FIG. 1) such as a plate and the like placed on the upper surface of the conveyance device 2. The visual sensor 50 is a camera such as a two dimensional camera and the like, for example. As the visual sensor 50, another type of sensor capable of acquiring image data or detected data of the target 60 can be used.

As shown in FIG. 3, the controller 20 includes a CPU, a processor 21 having one or a plurality of processor elements such as a microcomputer and the like, and a display device 22. The controller 20 has a storage unit 23 having a non-volatile storage, a ROM, a RAM, and the like. The controller 20 has servo controllers 24 that correspond to the respective servo motors 11 of the robot 10 and a servo controller 25 that corresponds to the servo motor 31 of the tool 30. The controller 20 also includes an input unit 26 connected to the controller 20 in a wired or wireless manner. In one example, the input unit 26 is an input device such as an operation panel and the like that can be carried by a user. In another example, the input unit 26 is a table computer. In such a case where the input unit 26 is the tablet computer, input is made by using a touch screen function. There is also a case where the operation panel or the tablet computer has the display device 22.

The storage unit 23 stores a system program 23a, and the system program 23a plays basic functions of the controller 20. In addition, the storage unit 23 stores an operation program 23b. The storage unit 23 also stores a parameter setting program 23c and a setting check program 23d. The controller 20 controls the arm 10a to perform a predetermined work on the work target W based on the operation program 23b.

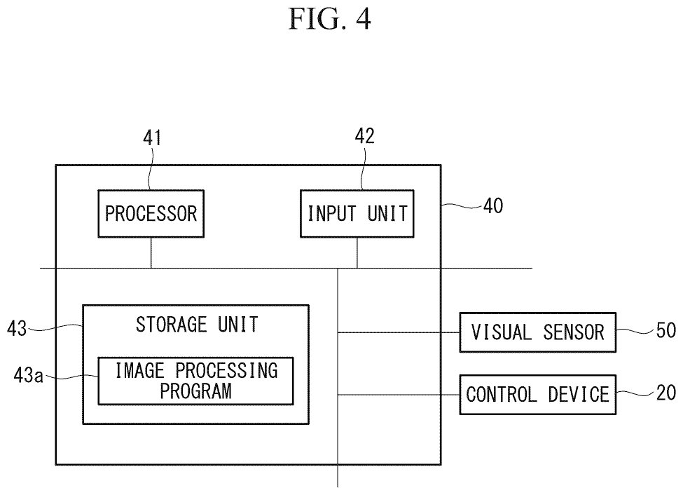

As shown in FIG. 4, the image processor 40 includes a processor 41 having one or a plurality of processor elements such as a CPU, a microcomputer, an image processing processor, and the like. The image processor 40 is connected to the controller 20 and the visual sensor 50 and includes an input unit 42 and a storage unit 43 having a non-volatile storage, a ROM, a RAM, and the like. The storage unit 43 stores a known image processing program 43a.

The image processor 40 performs known image processing on image data acquired by the visual sensor 50 based on the image processing program 43a. For example, the image processor 40 performs processing, such as known binarization processing, blob analysis processing, edge detection processing, and the like on the image data of the target 60. The image processor 40 may acquire position detection data such as a characteristic position, a gravity center position, and the like of the target 60. The image processor 40 also can acquire orientation detection data of the target 60. The image processor 40 sequentially transmits the image data on which the image processing is performed, the position detection data, the orientation detection data, and the like to the controller 20.

The controller 20 may play a part of or entire function of the image processor 40, and the image processor 40 may play a part of or the entire function of the controller 20. Also, another computer may play a part of or the entire function of the image processor 40 and the controller 20. In the following description, the image processor 40, the controller 20, and the other computer are referred to as a controller, and one or a plurality of processors of the controller performs the later described computer processing. One or a plurality of processors are a processor 21, a processor 41, and the like.

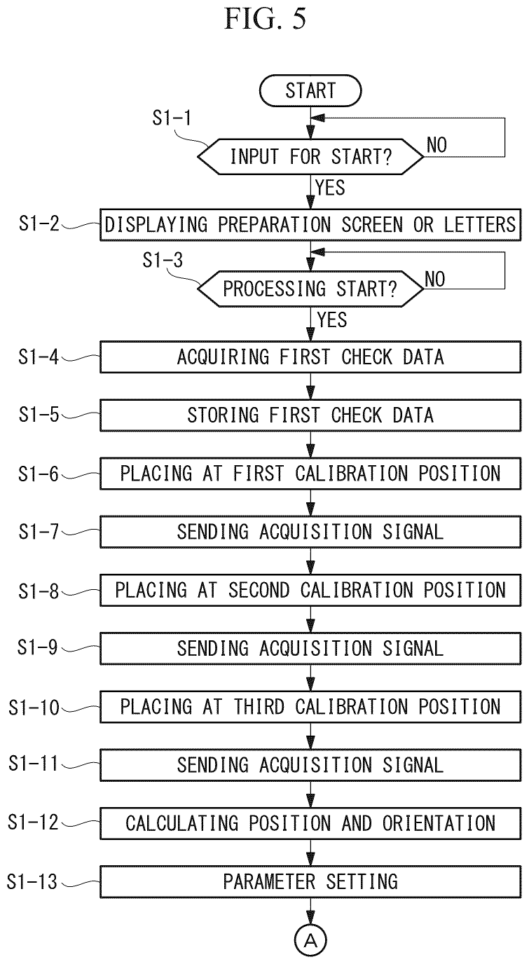

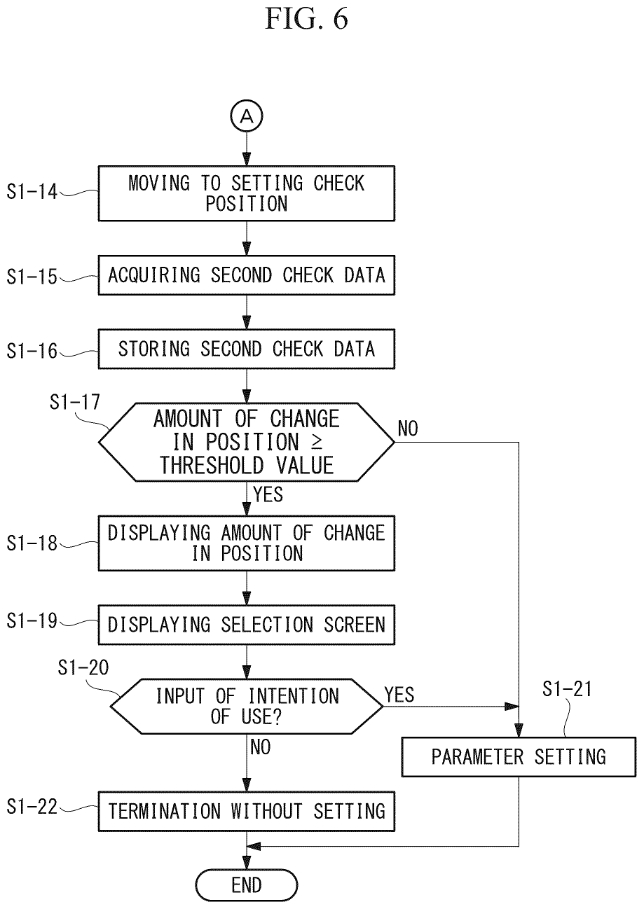

The controller performs the following processing in order to set parameters based on the parameter setting program 23c and the setting check program 23d. One example of the parameter setting will be described with reference to the flowcharts in FIGS. 5 and 6.

Here, as shown in FIG. 1, a reference coordinate system 101 of the arm 10a of the robot 10 is set in advance with reference to a base portion 13 for supporting the arm 10a as a reference, for example. Also, the controller can calculate a position and orientation of distal end portion coordinate system 102 of the distal end portion of the arm 10a such as a flange 10b and the like based on the detected result of the operating-position detection device 11a.

In the first embodiment, a target (a first setting element) 60 such as a calibration jig and the like is attached to the distal end portion of the arm 10a for setting the parameter. In one example, as shown in FIG. 1, the target 60 is held by the tool 30. The target 60 may be attached to a wrist flange 10b by means of a magnet such as an electromagnet, an attachment means such as a bolt, and the like. In the first embodiment, a center position of a mark 61 of the target 60 is placed at a position corresponding to a tool center point (TCP) of the tool 30.

Also, in the first embodiment, a visual sensor (a second setting element) 50 is supported by means of a support portion 70 for setting the parameter. The support portion 70 may be an upper surface of the conveyance device 2, and it may be a support device such as a tripod, and the like. For example, the position and the orientation of the visual sensor 50 on the support portion 70 are associated with a work-reference coordinate system for the work target W. The work-reference coordinate system is associated with the position and the orientation of the work target W, the position and the orientation of a placement portion of the work target W, and the like. In the first embodiment, the work-reference coordinate system and a sensor coordinate system 103 are associated with each other. By this, the later described parameter setting will allow the arm 10a to accurately execute the work on the work target W. In the first embodiment, an optical axis of the visual sensor 50 is associated with one axis such as Z axis and the like of the sensor coordinate system 103 and extends in a vertically upward direction, however, the optical axis of the visual sensor 50 may be oriented toward a different direction.

The target 60 of the first embodiment has the mark 61, and the controller recognizes a size and a shape of the mark 61, location of each element, and the like in advance. By this, the controller calculates the position and the orientation of the mark 61 and the target 60 with respect to the visual sensor 50 based on the acquired image data of the mark 61. For example, the center position of the mark 61 is calculated as the position of the mark 61, and the orientation of the mark 61 is calculated based on three or more feature shapes of the mark 61 or a relative position of a feature point. The mark 61 may be a dot pattern, a single or a plurality of three-dimensional shapes, and the like. When the target 60 is the work target W, one or a plurality of the feature shapes and the like of the work target W function as the mark 61. A narrow distal end portion may be provided in the target 60, and the distal end portion may be used instead of the mark 61.

Firstly, when input for starting a parameter setting is accepted (step S101), the controller executes the following processing based on the setting check program 23d. In one example, the input for the start is based on the input to the input unit 26 by the user.

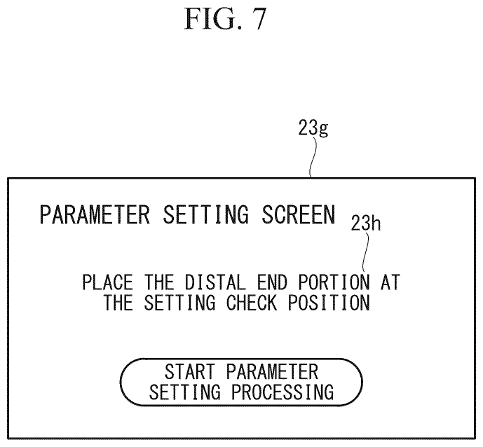

Here, the user moves the distal end portion of the arm 10a so that the target 60 enters into a field of vision of the visual sensor 50. At this time, the parameter setting screen 23g shown in FIG. 7 is displayed on the display device 22. Preferably, the controller displays a preparation screen or letters 23h on the display device 22 to encourage the user to place the distal end portion of the arm 10a in the setting check position (step S1-2). The controller may display a preparation screen or letters 23h on the display device to encourage the user to place the target 60 in the setting check position.

Terms used for the setting check position indicate the position and the orientation of the distal end portion of the arm 10a, and the setting check position is the position and the orientation of the distal end portion at which the target 60 is placed within the field of view of the visual sensor 50. The preparation screen or the letters 23h of step S1-2 may be a screen that informs the user that the setting check position will be used for determination made in step S1-17 which will be described later. In this case, the user can appropriately set the position and the orientation of the distal end portion in step S1-1 in consideration of various conditions. The various conditions are a structure including a wiring of the robot 10, a structure including a wiring of the visual sensor 50, a size of the robot 10, a type of the tool 30, a size of the tool 30, and the like. Also, the controller can be configured not to execute the step S1-2 in such a case where a content related to step S1-2 is written in an instruction manual and the like.

When an input to start processing of parameter setting is accepted (step S1-3), the controller controls the visual sensor 50 to acquire first check data 23e (FIG. 3) at the setting check position (step S1-4). Also, the controller stores the first check data 23e which is image data or detected data acquired by the visual sensor 50 in the storage unit 23 (step S1-5). Prior to step S1-4, the controller may cause the arm 10a to perform an operation for eliminating an effect of the backlash of the arm 10a. In one example, for such operation, the controller makes the servo motors 11 move to their original positions after rotating them slightly.

Subsequently, the controller executes the following processing based on the parameter setting program 23c. The controller controls the arm 10a to place the target 60 at a plurality of positions, for example, at more than three calibration positions, and controls the visual sensor 50 to capture images at each calibration position. The orientation of the target 60 at each of the calibration positions may be different from each other.

For example, the controller places the target 60 at a first calibration position (step S1-6) and controls the visual sensor 50 to acquire data at the first calibration position (step S1-7). Also, the controller places the target 60 at a second calibration position (step S1-8) and controls the visual sensor 50 to acquire data at the second calibration position (step S1-9). Also, the controller places the target 60 at a third calibration position (step S1-10) and controls the visual sensor 50 to acquire data at the third calibration position (step S1-11).

The controller calculates the position and the orientation of the target 60 with respect to the visual sensor 50 at each of the calibration positions from the image data acquired in steps S1-7, S1-9, and S1-11 (step S1-12). These positions and orientations are the positions and orientations of the target 60 on the sensor coordinate system 103 of the visual sensor 50. Also, the controller recognizes at least one of the positions and the orientations of the distal end portion of the arm 10a, the tool 30, and the distal end portion coordinate system 102 at each of the calibration positions. The controller sets the parameter using the position and the orientation on the sensor coordinate system 103, and the position and the orientation on the distal end portion coordinate system 102 at each of the calibration positions, for example (step S1-13).

This parameter is to associate the sensor coordinate system 103 with the distal end portion coordinate system 102 and the reference coordinate system 101, for example. This parameter is to associate the work-reference coordinate system with the positions and orientations of the distal end portion of the arm 10a, the tool 30, and the distal end portion coordinate system 102, for example. The arm 10a can perform the work accurately if the sensor coordinate system 103 is associated with a coordinate system of the conveyance device 2. Alternatively, this parameter is to associate the distal end portion coordinate system 102 with a distal end portion of the tool 30 (TCP).

This parameter may be used for a different purpose, and a different calculation method can be adopted for setting this parameter. Also, in the first embodiment, the position and the orientation of the visual sensor 50 is associated with the work-reference coordinate system for the work target W.

Instead of this, the controller 20 may recognize the position and the orientation of the TCP in the absence of this correspondence.

Next, the controller executes the following processing based on the setting check program 23d. The controller controls the arm 10a so that the distal end portion of the arm 10a is placed at the setting check position (step S1-14). Also, the controller controls the visual sensor 50 to acquire second check data 23f (FIG. 3) at the setting check position (step S1-15). Also, the controller stores the second check data 23f that is image data or detected data acquired by the visual sensor 50 in the storage unit 23 and the like (step S1-16).

Subsequently, the controller determines whether or not there is a change in position of the visual sensor 50 or the target 60 by comparing the check data 23e and the check data 23f (step S1-17). For example, it is determined that the change in position is not made when the amount of change in position of the target 60 in the second check data 23f with respect to that in the first check data 23e is less than a threshold value. At this time, the controller displays an indication of termination of the parameter setting on the display device 22 (step S1-21), and terminates the processing of the parameter setting properly. Also, it is determined that there is a change in position when the amount of the change in position is more than the threshold value. The threshold value is, for example, three pixels of the image data acquired by the visual sensor 50, however, if it is determined that there is the change in position when the threshold value is two pixels or more, the parameter can be set more accurately.

As the threshold, it is possible to determine whether there is the change in position by setting 0.5 mm as the threshold value. For example, the amount of the change in position is the amount of the change in position on a portion where the largest displacement occurs on the mark 61 on the target 60. The parameter setting will be more accurate if it is determined that there is the change in position when the amount of the change in position is more than 0.3 mm or 0.2 mm, instead of more than 0.5 mm. For example, the position of the visual sensor 50 may slightly be shifted while setting the parameter due to tension acted on a cable of the visual sensor 50. Since this phenomenon occurs during the parameter setting that takes a relatively short time, it is possible to determine the slight change in position of the visual sensor 50 or the target 60 accurately. Note that it is also possible to use a threshold value greater than the above described values depending on a situation or a condition.

Subsequently, when it is determined there is the change in position in step S1-17, the controller displays an indication of the amount of the change in position on the display device 22 (step S1-18). The number of pixels, a value in millimeter scale, and the like are used as the amount of the change in position. In step S1-18, the controller may display a determination that there is the change in position on the display device 22. As the displayed screen of the determination, an error indication, an indication notifying that the parameter cannot be set, and the like can also be used. This allows the user to know the change in position in a timely manner.

Also, when it is determined that there is no change in position in step S1-17, the controller may display the indication that there is no change in position on the display device 22. This allows the user to know that the parameter set by the user is accurate in a timely manner. As the display notifying that there is no change in position, the amount of the change in position may be displayed on the display device 22. Moreover, if letters and color of the screen for indicating the amount of the change in position in the above described manner are made different from those in step S1-18, the user can easily recognize that there is no change in position.

Further, the display of the change amount of the position allows the user to estimate accuracy of the parameter setting. For example, there may be a case in which the tool 30 is an elongated welding gun, a hand with a long claw, or the like, and the target 60 may be attached to its distal end portion. For example, not much accuracy of the position may be required for a work by using the tool 30.

Also there are the above described various conditions. If these conditions are used, the user can determine whether four pixels are adequate based on the above conditions, experience, and the like. Also, there may be a case in which the user can estimate the accuracy of the parameter setting based on the adequacy.

The controller may display a direction of the change in position on the display device 22. In this case, a direction of the change in position of the visual sensor 50, a direction of the change in position of the target 60, and the like are displayed on the display device 22. Those directions may be approximate directions. This display enables the user to estimate a cause of the change in position easily, which improves the efficiency of setting work.

In consideration of the above case, the controller may display a selection screen that allows the user to select whether or not to use the parameter on the display device 22 when it is determined that there is the change in position in step S1-17 (step S1-19). This allows the users to determine whether or not to use the parameter based on the conditions, experience, and the like. Also, when it is not necessary to make the selection and the like, the controller is configured to skip step S1-19.

Also, the controller may store the data, in which the selection result, the amount of the change in position, and the parameter are associated with each other, in the storage unit 23 when the user selects to use the parameter in step S1-19.

Alternatively, the controller may store data in which the amount of the change in position and the parameter are associated with each other in the storage unit 23 when it is determined that there is the change in position in step S1-17.

Or, the controller may send the data to an external computer. This external computer is a server and the like used for production management and quality management. This data can be used for quality management tasks, design and improvement of the robot system, design and improvement of the work target W, and the like which will be executed later.

And, when the controller accepts an input to use the parameter which is made by the input unit 26 and the like (step S1-10), the controller sets the parameter and displays the termination of the parameter setting (step S1-21). When the controller does not accept the input to use the parameter (step S1-20), the step is terminated without setting the parameter (step S1-22).

Also, the controller may place the distal end portion of the arm 10a at the setting check position automatically instead of executing the step S1-2. At that time, the controller may display a plurality of the setting check positions as selection options by using a figure and the like displayed on the display device 22. In this case, the controller displays a screen for selecting any one of the plurality of the setting check positions on the display device 22. The controller accepts the selection input of the user via the input unit 26 and automatically places the distal end portion of the arm 10a at the setting check position corresponding to the selection input.

Also, the controller may display a screen that allows the user to set the setting check position. For example, a screen that shows at least the position of the visual sensor 50 is displayed. This screen allows the user to designate at least the position of the distal end portion of the arm 10a, tool 30, or the target 60. The controller accepts the setting input of the user via the input unit 26 and automatically places the distal end portion of the arm 10a at the setting check position corresponding to the setting input.

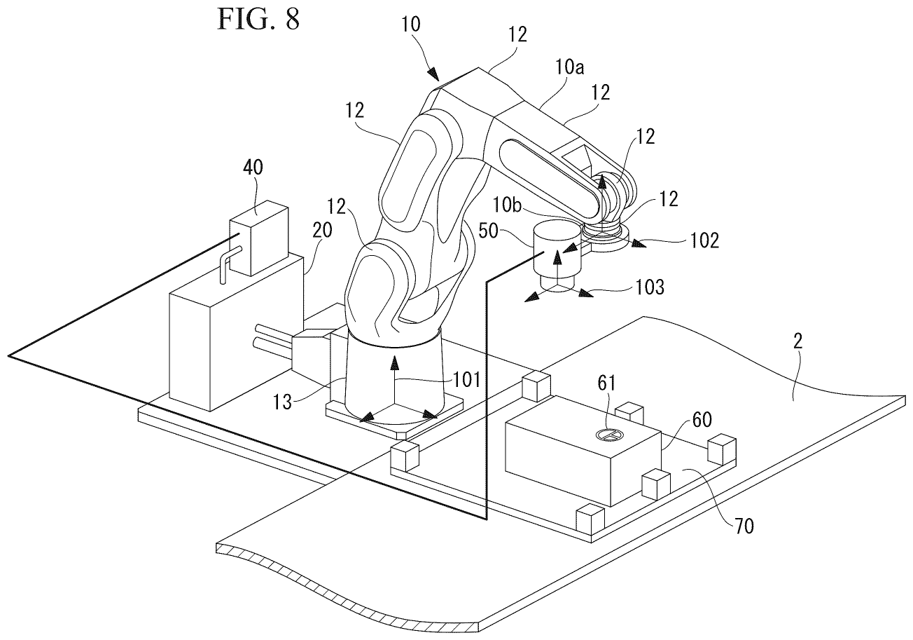

A robot parameter setting apparatus of a second embodiment will be described with reference to the drawings. In the first embodiment, the target (first setting element) 60 is attached to the distal end portion of the arm 10, and the visual sensor (second setting element) 50 is supported by the support portion 70. In the second embodiment, the visual sensor (a first setting element) 50 is attached to the distal end portion of the arm 10a, and the target (a second setting element) 60 is supported by a support portion 70 (FIG. 8). In the second embodiment, a component that is the same as or corresponding to the first embodiment is represented by the same reference symbols and its description will be omitted. Moreover, a modified example explained in the first embodiment is applicable to the second embodiment accordingly as well.

In the second embodiment, the visual sensor 50 is removably attached to the distal end portion of the arm 10a. In one example, the visual sensor 50 is attached to a wrist flange 10b of the arm 10a in the same manner as the tool 30. In one example, the target 60 is supported by the upper surface of the conveyance device 2. In the second embodiment, the target 60 is supported by the support portion 70 placed on the upper surface of the conveyance device 2. The target 60 may be a work target W, an object other than the work target W, a part of structure, and the like. It is possible to use a part of the conveyance device 2 and the like as the part of structure.

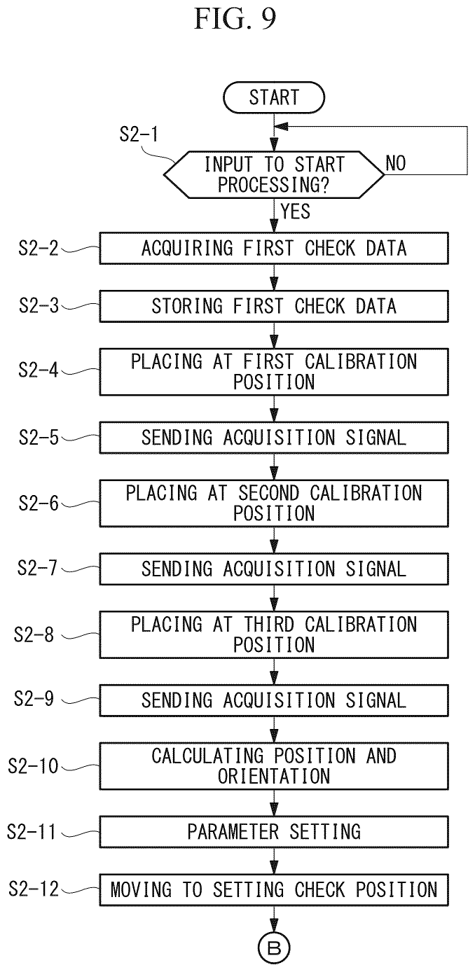

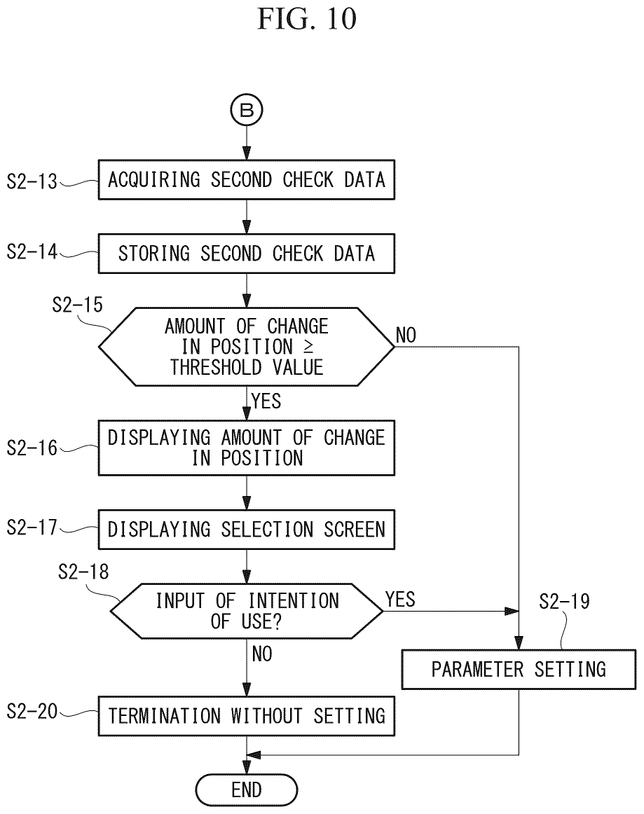

In the second embodiment as well, the following processing for setting the parameter is executed according to the parameter setting program 23c and the setting check program 23d. An example of the parameter setting will be described with reference to the flowcharts of FIGS. 9 and 10.

In the second embodiment, the visual sensor 50 is attached to the distal end portion of the arm 10a for setting the parameter. In one example, the visual sensor 50 is attached to the wrist flange 10b by means of a magnet such as an electromagnet and the like, or an attaching means such as a bolt and the like. The visual sensor 50 may be attached to the distal end portion of the arm 10a by supporting the visual sensor 50 using the tool 30.

Also, in the second embodiment, the target 60 is supported by the support portion 70 for setting the parameter. The support portion 70 may be an upper surface of the conveyance device 2, and it may be a support device such as a tripod and the like. For example, the position and the orientation of the target 60 on the support portion 70 are associated with those on the work-reference coordinate system for the work target W. In this sense, it is possible to set the parameter to be suitable for the work when the plurality or the single work target W is used as the target 60. The camera coordinate system 103 and the reference coordinate system 101 and the distal end portion coordinate system 102 are associated with each other by using the later described parameter setting, for example. Also, the later described parameter setting allows the arm 10a to work on the work target W accurately, for example.

Firstly, the controller executes the following processing based on the setting check program 23d.

In the second embodiment, the user moves the distal end portion of the arm 10a so that the target 60 enters into an angle of view of the visual sensor 50 according to descriptions of the instruction manual. In the second embodiment, the controller does not display a preparation image or the letters 23h that encourages the users to place the distal end portion of the arm 10a at the setting check position. The first embodiment can also be configured in the similar way.

When the input to start processing of parameter setting is accepted (step S2-1), the controller controls the visual sensor 50 to acquire the first check data 23e at the setting check position (step S2-2). Also, the controller stores the first check data 23e which is image data or detected data acquired by the visual sensor 50 in the storage unit 23 and the like (step S2-3). Before executing step S2-2, the controller may control the arm 10a to execute an operation for eliminating an effect of the backlash of the arm 10a.

Subsequently, the controller executes the following processing according to the parameter setting program 23c in the same way as the first embodiment.

For example, the controller places the visual sensor 50 at the first calibration position (step S2-4) and controls the visual sensor 50 to acquire data at the first calibration position (step S2-5). Also, the controller places the visual sensor 50 at the second calibration position (step S2-6) and controls the visual sensor 50 to acquire data at the second calibration position (step S2-7). Also, the controller places the visual sensor 50 at the third calibration position (step S2-8) and controls the visual sensor 50 to acquire data at the third calibration position (step S2-9).

The controller calculates the position and the orientation of the target 60 with respect to the visual sensor 50 at each of the calibration positions from the acquired image data in steps S2-5, S2-7, S2-9 (step S2-10). These positions and the orientations are the positions and the orientations of the visual sensor 60 on the sensor coordinate system 103. Also, the controller recognizes the position and the orientation of at least one of the distal end portion of the arm 10a, the tool 30, and the distal end portion coordinate system 102. The controller sets the parameter by using the position and the orientation on the sensor coordinate system 103 and the position and the orientation on the distal end portion coordinate system 102 at each of the calibration positions, for example (step S2-11).

The parameter is to associate the sensor coordinate system 103 with the distal end portion coordinate system 102 and the reference coordinate system 101, for example.

The parameter may be a parameter for other purposes, and other calculation methods may be adopted for setting the parameter.

Subsequently, the controller executes the following processing based on the setting check program 23d. The controller controls the arm 10a to place the distal end portion of the arm 10a at the setting check position (step S2-12). Also, the controller controls the visual sensor 50 to acquire the second check data 23f at the setting check position (step S2-13). And, the controller stores the image data or the detected data acquired by the visual sensor 50 in the storage unit 23 and the like (step S2-14).

Next, the controller determines whether or not there is the change in position of the visual sensor 50 or the target 60 in the same manner as in step S1-17 of the first embodiment (step S2-15). When there is no change in position, the controller displays the indication of termination of the parameter setting on the display device 22 (step S2-19) and successfully terminates the processing of the parameter setting.

Also, the controller displays the indication of the amount of the change in position on the display device 22 in the same manner as in step S1-18 of the first embodiment (step S2-16). This indication of the amount of the change in position enables the user to estimate the accuracy of the parameter setting in the same manner as in the first embodiment.

Also, the controller may display the selection screen on the display device 22 in the same manner as in step S1-19 of the first embodiment (step S2-17). In this way, the user can determine whether or not to use the parameter based on the condition, the experience, and the like in the same manner as in the first embodiment.

Also, when the controller accepts the input to use the parameter input by the input unit 26 and the like (step S2-19), the controller sets and displays the indication of the termination of the parameter setting (step S2-19). In such a case where the controller does not accept the input to use the parameter (step S2-18), controller terminates the processing without setting the parameter (step S2-20).

Here, in the processing of the parameter setting, the distal end portion of the robot 10 moves to pluralities of positions and orientations in sequence in the same manner as in steps S1-6 to S1-11 of the first embodiment, for example. Also, there are various objects such as other devices, the work targets W, and the like around the robot 10. Also, a cable for the robot 10 also exists around the robot 10, and the cable also moves according to the operation of the robot 10. For that reason, the user needs to be careful not to cause interference between the robot 10 and cable with the surrounding objects while setting the parameter. Therefore, in many cases, the user does not notice the state of the visual sensor 50 and its cable.

Also, the visual sensor 50 is attached to the robot 10 or the support portion for the user and the like to set the parameter, and its cable is also placed temporality by the user. Therefore, the visual sensor 50 may apply slight tension to the cable during the parameter setting operation of the robot 10 depending on the temporality position of the cable. The visual sensor 50 may be moved by this slight tension or may not be moved. In addition, when the visual sensor 50 is displaced slightly by the slight tension, the user does not notice it in many cases. Despite of the possibility that the target 60 is slightly displaced due to oscillation and the like, the user may not notice it in many cases as well.

In one example, the calculation for the parameter setting is executed even when there is the slight displacement, and therefore, the parameter processing is terminated without any problem and the user does not notice the displacement.

Depending on the accuracy required for the work executed on the work target W by the robot 10, there is a work in which the user does not notice the slight displacement at all.

However, even in this kind of work also, when an error occurs, the cause may be related to the slight displacement.

In the first and the second embodiments, measurement of the first and the second check data 23e, 23f and determination of whether there is the change in position are made during a series of controls for the parameter setting of the robot 10. In this configuration, the first and the second check data 23e, 23f are measured during the parameter setting which takes a relatively short time, it is possible to accurately determine whether there is the slight displacement of the visual sensor 50 or the target 60 which occurs during the parameter setting.

For example, it is determined that there is the change in position if the positions in the first check data 23e and that in the second check data 23 are different by three pixels or more in step S1-17. In one example, the visual sensor 50 has millions of pixels, and one side of the angle of view of the visual sensor 50 at the position of the target 60 is about ten to twenty centimeters. In this case, the change in position by three pixels can correspond to a change in position by 0.2 mm, 0.3 mm, and the like. Therefore, the above described configuration can accurately determine whether there is the slight displacement of the visual sensor 50 or the target 60.

If the visual sensor 50 is slightly displaced in its optical axis direction when capturing images at a second setting check position, the displacement hardly occurs only in the optical axis direction of the visuals sensor 50. That is, when the position of the visual sensor 50 is shifted in the optical axis direction for an unintended reason, it is unlikely that the visual sensor 50 is not displaced in the direction that intersects the optical axis. The same is applied to the target 60. Therefore, the above configuration can accurately determine whether there is the slight displacement of the visual sensor 50 or the target 60.

Also, in the first and the second embodiments, the user moves the distal end portion of the arm 10a before executing steps S1-4 and S2-2, and the position of the distal end portion of the arm 10a is used as the setting check position. As a result, the user can determine the setting check position easily and certainly so that the user is not required to set the setting check positions separately. This contributes to an improvement of the convenience of the user. Also, the user can certainly place the visual sensor 50 at a position where the visual sensor 50 is in focus as the setting check position. Considering that many of the visual sensors 50 for the robot 10 do not have an autofocus function and an area of focus is known from an instruction manual and the like, this configuration is useful.

Also, in the first and the second embodiments, the screen for selecting the setting check position is displayed. Therefore, the user can easily use the setting check position that is suitable for conditions such as wiring, a position, and the like of the cable of the visual sensor 50.

Also, in the first and the second embodiments, the screen for setting the setting check position is displayed. This is useful for the user to arbitrary set the setting check position without taking time and effort.

Also, in the first and the second embodiments, any one of the calibration positions can be used as the setting check position. For example, in such a case where the first calibration position is used as the setting check position, the distal end portion of the arm 10a is placed at the first calibration position in steps S1-14 and S2-12. In this case also, the similar effect can be achieved. Also, it is preferable that the setting check position is the position in the first half part of the setting operation in steps S1-6 to S1-11 of the first embodiment, for example. That is, it is preferable that the setting check position is the first calibration position or the second calibration position.

Also, preferably, in the first embodiment, the steps S1-12 and S1-13 are executed in the latter half of the setting operation in steps S1-6 to S1-11 or after this setting operation.

Also, in the first and the second embodiments, another setting check position may further be set. A position where the tension is highly likely be applied to the cable of the visual sensor 50 and the like can be set as the other setting check position, for example. The other setting check position may be any one of the calibration positions. The setting check position may automatically be set by the controller, or may be set by the controller in advance. In these cases, the controller may be configured to display the setting check position on the display device 22. For example, as the setting check position, the controller displays a position where the arm 10a stopped before the first calibration position, a position located between the first calibration position and the second calibration position, and the like. In this case, the user can know where the setting check position is, and this contributes to easy identification of the cause of the error at the time of the setting operation and the like.

Note that in the first and the second embodiments, the visual sensor 50 may be a three-dimensional camera, a three-dimensional distance sensor, a LiDAR (Light Detection and Ranging), PSD (Position Sensing Detector), and the like. In these cases, the configuration of the image processor 40 can be changed appropriately. Also, as the visual sensor 50, it may be possible to use a visual sensor that is attached to the distal end portion of the arm 10a while executing the work on the work target W.

While the embodiments of this disclosure are described, it is not limited to the individual embodiments described above. Various additions, substitutions, changes, partial deletions, and the like can be made in these embodiments within a range not departing from the gist of the invention, or within a range not departing from the concept and purport of the invention derived from the contents described in the claims and equivalents thereof. For example, in the above described embodiment, the order of operations, the order of processing, the omission or addition of some operations according to conditions, and the omission or addition of some processing according to conditions can be performed without being limited to the above described example. Also, the same applies to the case where numerical values or mathematical expressions are used in the description of the above described embodiment.

1. A robot parameter setting apparatus comprising:
a first setting element which is either one of a target and a sensor and which is attached to an arm of a robot;
a second setting element which is the other one of the target or the sensor; and
a controller configured to control the arm to execute parameter setting operation for setting parameter by placing the first setting element at a plurality of positions, wherein
the controller is configured to control the sensor to acquire first check data related to the target in a state in which the first setting element is placed at a setting check position in a first half of the setting operation or before executing the setting operation,
the controller is configured to control the arm to execute a movement for placing the first setting element at the setting check position in a latter half of the setting operation or after executing the setting operation, and then controls the sensor to acquire second check data related to the target, and
the controller is configured to judge whether or not there is a change in position of the first setting element or the second setting element based on the first check data and the second check data.

2. The robot parameter setting apparatus according to claim 1, wherein the controller uses a position, as the setting check position, at which the first setting element is placed by a user moving the arm before placing the first setting element at the plurality of positions for the parameter setting operation.

3. The robot parameter setting apparatus according to claim 1, further comprising a display device configured to display a judgement that there is the change in position.

4. The robot parameter setting apparatus according to claim 1, further comprising a display device configured to display an amount of the change in position when there is the change in position.

5. The robot parameter setting apparatus according to claim 1, further comprising a display device configured to display a direction of the change in position when there is the change in position.

6. The robot parameter setting apparatus according to claim 1, further comprising a display device configured to display a screen for the user to set the setting check position or a screen for allowing the user to select the setting check position.

7. The robot parameter setting apparatus according to claim 1, wherein the robot parameter setting apparatus is configured to display a screen for having the user select whether or not to use the set parameter when the controller judges that there is the change in position.

8. The robot parameter setting apparatus according to claim 1, wherein the second setting element is supported by a predetermined support portion.

9. A robot comprising the robot parameter setting apparatus according to claim 1.
